(19) United States
(12) Patent Application Publication
(10) Pub. No.: US 2007/0024825 A1
(43) Pub. Date: Feb. 1, 2007

(54) Light valve projection systems with light recycling

(76) Inventor: Adrianus Johannes Stephanes Maria De Vaan, S-Hertogenbosch (NL)

Correspondence Address: PHILIPS INTELLECTUAL PROPERTY & STANDARDS, P.O. BOX 3001, BRIARCLIFF MANOR, NY, 10510, US

(21) Appl. No.: 11/189,293

(22) Filed: Jul. 26, 2005

(51) Int. Cl. G03B 21/28

(52) U.S. Cl. 353/98

(57) ABSTRACT

A light valve system adapted to recycle light reflected from the light valve in order to improve the brightness of the image. Illustratively, this reflected light is the dark-state light of an image. For example, a light valve is optically coupled to a polarization or TIR discriminator; and a light recycling device selectively alters the polarization state of light reflected by the polarization discriminator back into the system, and the reflected light is transmitted to an imaging surface increasing the image brightness.

Light valve technology has been applied in projection displays for use in projection televisions, computer monitors, point of sale displays, and electronic cinema to mention only a few applications. Different types of light valve technology for projection systems exist.

A first type of projection light valve technology is using an array of tiny mirrors that can be actuated to reflect light from a light source into a projection lens such it can hit a projection screen, or that the mirror can reflect the light into a direction next to the projection lens where it is absorb by a light trap. Today, the most commonly used light valve of this kind are the DMD (Deformable Mirror Array) as manufactured and marketed by TI (Texas Instrument), each panel containing a large array of pixels in the order of 14 um size per pixel.

A second type of projection light valve technology is using miniaturized LC (Liquid Crystal) technology. In these projectors the small LCD (Liquid Crystal Display) panels illuminated with a light beam originating from a projection light source. The illumination light beam is made linear polarized using polarization optical components like commonly known by the experts in the field. The individual pixels in the LCD panels modulate the polarization direction of the light traversing through the LC layer after which this polarized modulated light is analyzed by the so called analyzer, where the polarization modulated light beam is changed in an intensity modulated one. Dependent on the orientation states of the LC layer in the LCD panels, 2 major states can be found, being the brightest and the darkest state of the panel. In the brightest state, the polarization direction of the light leaving the LCD panels matches with the transmission axis of the analyzer, meaning that this light will hit the screen with a high intensity. In the darkest state, the polarization direction of the light leaving the LCD panels matches the absorption axis of the analyzer; the analyzer will absorb most of the light meaning that this light will reach the screen with its lowest intensity.

A more recent application of LC devices is the reflective LC display on a silicon substrate (LCoS). Silicon-based reflective LC displays often include an active matrix array of complementary metal-oxide-semiconductor (CMOS) transistors/switches that are used to selectively rotate the axes of the liquid crystal molecules. As is well known, by application of a voltage across the LC cell, the plane of polarization of the reflected light is selectively rotated. As such, by selective switching of the transistors in the array, the LC medium can be used to modulate the light with image information. This modulated light can then be imaged on a screen by projection optics thereby forming the image or ‘picture.’

In many LCD systems, the light from a source is selectively polarized in a particular orientation prior to being incident on the liquid crystal material. This is often carried out using a polarizer between the light source and the liquid crystal. As can be appreciated, this type of system will result in a significant loss of light. For example, in a system where the light is randomly polarized or unpolarized, half of the light energy is not transmitted to the liquid crystal, and is therefore, lost.

Moreover, in less than ideal light valve projectors each pixel that is ‘dark’ in a particular frame or image results from the prevention of light from reaching the image surface. Often, the creation of dark-state light results from the polarization selection by a device (e.g., a polarization beam splitter, or a absorption type of polarizer); or by absorption of the light in a light trap. However, this results inefficient light loss at the imaging surface. The inefficiencies of known systems can have deleterious effects on the image displayed. For example, losses in light energy can result in reduced brightness.

In flash-illumination systems, where the display is illuminated with a single color at a time and this color is sequentially changed, by definition two thirds of the light from the white-light source is lost. To wit, if red is illuminating the screen in a particular frame, the green and blue light are lost. In such systems, a color wheel or other type of time-varying light filter may be used to selectively project light onto the display, and selectively reflect or absorb the other light. Like known LCD-based systems, known flash-illumination systems are exceedingly inefficient from the perspective of lost brightness.

What is needed therefore is a method and apparatus that addresses at least the shortcomings of known systems described above.

In accordance with an example embodiment, a light valve system for recycling light to increase the brightness of an image includes a light source, a light valve optically coupled to a polarization or total internal reflection (TIR) based discriminator; and a light recycling device disposed to transmit light reflected from the polarization or TIR based discriminator to an imaging surface.

In accordance with another example embodiment, a method of recycling light in a light valve system includes optically coupling a light valve to a TIR based discriminator and increasing the brightness of an image by recycling light reflected by the TIR discriminator back to the system and transmitting the reflected light to an imaging surface.

In accordance with another example embodiment, a method of recycling light in a light valve system includes selectively reflecting a portion of light received from a light valve back to the system, selectively altering the polarization state of light reflected back into the system, and increasing the brightness of an image by transmitting the reflected light to an imaging surface.

The invention can be better understood from the following detailed description when read with the accompanying drawing figures. It is emphasized that the various features are not necessarily drawn to scale. In fact, the dimensions may be arbitrarily increased or decreased for clarity of discussion.

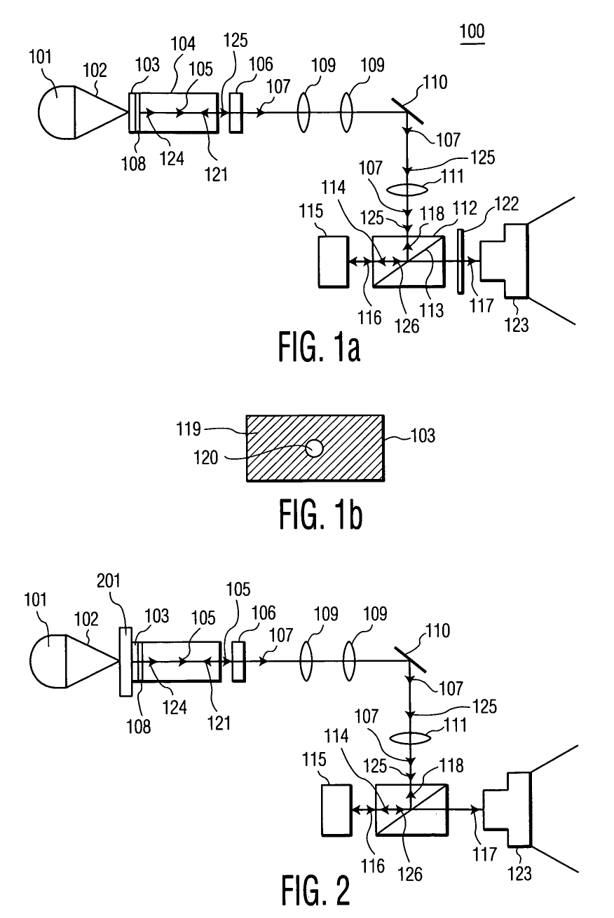

FIG. 1a is a schematic diagram of a light valve projection system in accordance with an example embodiment.

FIG. 1b is a perspective view of a reflective element with an aperture in accordance with an example embodiment.

FIG. 2 is a schematic diagram of a light valve projection system in accordance with an example embodiment.

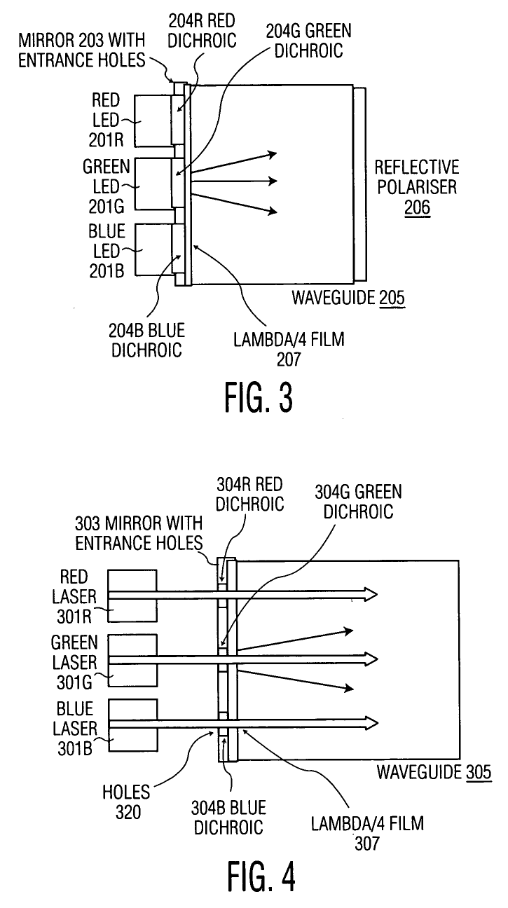

FIG. 3 is a schematic of a second light valve projection system in accordance with an example embodiment.

FIG. 4 is a schematic of a third light valve projection system in accordance with an example embodiment.

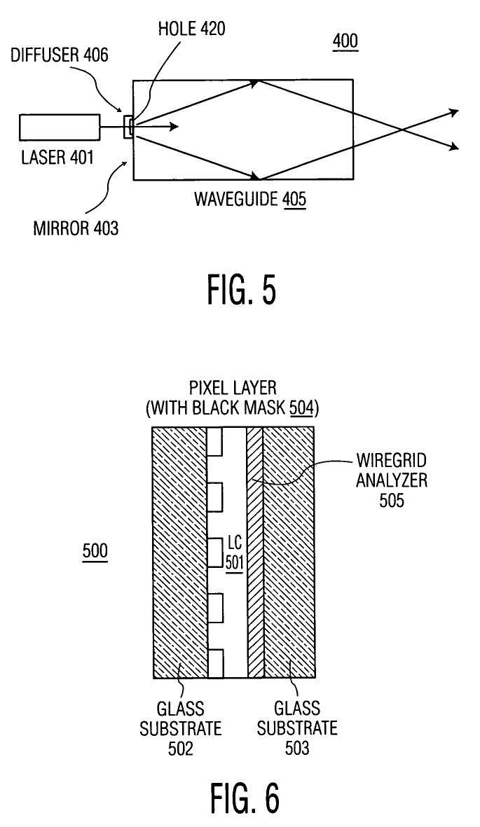

FIG. 5 is a schematic of a fourth light valve projection system in accordance with an example embodiment.

FIG. 6 is a schematic of an LCD of a transmissive type usable in some of the example embodiments

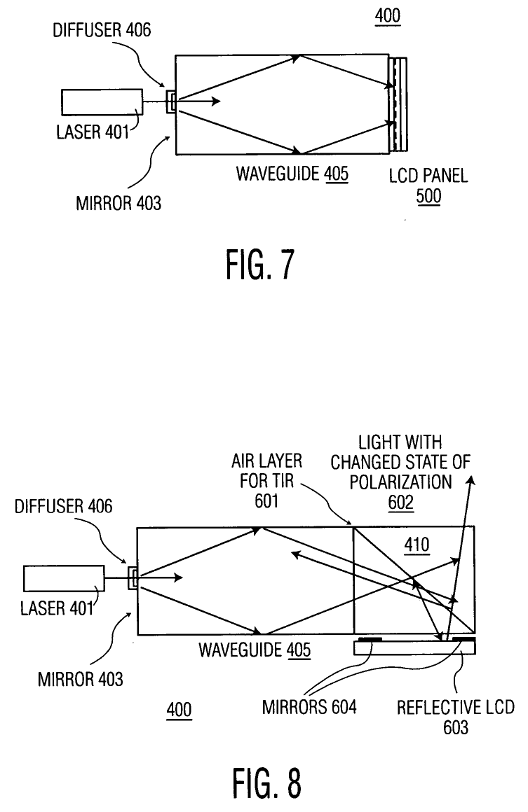

FIG. 7 is a schematic of a fifth light valve projection system in accordance with an example embodiment.

FIG. 8 is a schematic of a sixth light valve projection system in accordance with an example embodiment.

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention. Wherever possible, like numerals refer to like features throughout.

Briefly, in accordance with example embodiments, light valve projection systems include a method and apparatus for recycling light to improve the overall brightness of the image at the viewing surface (projection screen). Illustratively, the projection systems of example embodiments are LCD-based, and include an optical structure, which recycles light that is not initially transmitted to the projection optics (e.g., dark state light). Illustratively, the recycled light is reflected back into the system by a polarization discriminator. Other light that is reflected back into the system may be similarly recycled by the optical structure. This recycling allows light that is precluded from reaching the screen initially to reach the screen, and thus increase the overall brightness levels of the image.

FIG. 1a shows a light valve system 100 for color sequential illumination in accordance with an example embodiment. The light valve system is illustratively a color sequential system with an LCD light valve. As described more fully herein, this is merely an illustrative embodiment. In fact, other light valve systems may benefit from the recycling of light realized from the example embodiments.

The light valve-system 100 includes a light source (not shown) that is disposed in a reflecting element 101, illustratively an elliptical/ellipsoid-shaped reflective element. As described in further detail below, the light 102 is substantially unpolarized multi-chromatic light. To wit, the light 102 from the light source is unpolarized or randomly polarized white light in the visible spectrum.

The light 102 is incident on a reflective element 103 coupled to a rod integrator 104. The reflective element 103 is shown on further detail in FIG. 1b. The reflective element 103 has reflective surfaces 119 on its opposing sides, and an aperture 120 that is substantially centered on the surface. The aperture 120 serves as the entrance to the rod integrator for the light 102, and as an exit opening for light returning in a direction of propagation opposite that of light 102. Moreover, the reflective element 103 usefully reflects returning light (i.e., light propagating toward the reflective element 102) that is incident thereon. It is noted that the details of this returning light will become clearer as the present description continues.

The portion of light 102, which is incident on the opening 120, is admitted to the rod integrator 104, while light which is incident on the reflective surface 119 is reflected back to the reflective element 101. This light may then be reflected back by the element 101 so that it is incident on the opening 120 and ultimately may improve the efficiency of light transmitting to the imaging surface (not shown).

A quarter-wave plate or similar retarder 108 is disposed adjacent to the reflective element 108, and, as described more fully herein, is useful in the recycling of light returned to the system. The quarter-wave retarder 108 usefully has a transmission axis that is at 45° or π/4 relative to the optic axis of a reflective polarizer 106. The rod integrator 104 is useful in providing a more uniform light beam to the light valve and thus the imaging surface or screen. To this end, the rod integrator 104 is illustratively a waveguide that substantially exhibits total internal reflection (TIR). For example, the integrator may be a cylindrical device or polygonal device with a rectangular or square cross-section.

In accordance with one illustrative embodiment, the rod integrator is rectangular that has a height-to-width ratio that is substantially identical to the ratio of the height to the width of the active surface of the light valve of the system 100 (e.g., the ratio of the height to width of an LCoS device). Further details of the rod integrator assembly may be found in U.S. Patent Publication No. 2003/0086066 A1 to Kato, the disclosure of which is specifically incorporated herein by reference.

The light valve system 100 also includes lens elements 109, which usefully focus or condense the light from the rod integrator/reflective polarizer in order to maintain the integrity of the light incident on the light valve. A mirror device 110 is usefully included to direct the light from/to the rod integrator/reflective element. As is known, the mirror 110 is useful in achieving a dimensionally compact system. The light reflected from the mirror is incident on another lens 111, again useful in maintaining the integrity of the light.

The light valve system 100 includes a polarization discriminator 112, which is illustratively a polarization beam splitter (PBS). The PBS is illustratively used as a reflective PBS, which reflects light of a first polarization state incident on an interface 113 of the PBS in a direction that is perpendicular to its original direction of propagation. Light of a second polarization state that is orthogonal to the first polarization state is transmitted substantially along its original trajectory. The use of a reflective PBS is beneficial because it is nearly completely efficient in reflecting the light in the manner described.

The system 100 includes a light valve 115, which is illustratively an LCoS device; although other types of light valves such as reflective twisted nematic (TN) LC-based TFT devices may be used. Characteristically, the light valve 113 selectively alters the polarization state of some picture elements (pixels) and does not alter others, thereby creating bright and dark pixels on the image surface. Generally, the light valve 115 may be one of a number of types of spatial light modulators. Illustratively, light valves including, but not limited to antiferroelectric and ferroelectric LC-based devices, horizontally or vertically oriented LC-based devices and high molecular-diverging LC-type devices may be used. The system 100 also includes a light shutter or a color shutter 122, which selectively transmits red, blue and green light sequentially, thereby providing color sequential imaging to projection optics 123. The color shutter 122 described in U.S. Pat. No. 6,273,571 to Sharp, et al. or other color shutters or color filters manufactured by ColorLink, Incorporated may be used in this manner. In operation, the color shutter 122 sequentially passes light of red, green and blue to the projection optics 123, and thus to the display surface (not shown).

In operation light 102 is incident on the reflective element 103 with some of the light 102 passing through the aperture 120. The light that passes through the aperture 120 traverses the quarter wave retarder 108, and the remaining light is reflected back toward the reflective element 101 by the reflective surface 119 of reflective element 103. The light 105 emerges from the quarter wave retarder 108 having orthogonal polarization components. The light 105 then traverses the rod integrator 104 and is homogenized or made more uniform, as is explained more fully in the application to Kato.

The reflective polarizer 106 reflects one of the polarization states (e.g., s-polarized light), while allowing light of the orthogonal state (e.g., p-polarized light) to emerge as polarized light 107. The polarized light 107 is then incident on the lens elements 109 and the mirror 110. The mirror 110 reflects the light in an orthogonal direction, and this light traverses the lens element 111.

Upon emerging from the lens element 111, the polarized light 107 is incident on the PBS 112, and substantially all of this polarized light is reflected from the interface 113 as reflected light 114. The light 114 is incident upon the light valve 115. The pixels of the light valve 112 selectively alter the polarization state of some of the light 114 causing it to undergo an orthogonal transformation of polarization state, while leaving some of the light 114 substantially in its original polarization state. This selective alteration of the polarization state is carried out on a pixel-by-pixel basis as is known to one of ordinary skill in the art.

In the present example embodiment, the light is reflected as light 116, and the light, which has undergone a polarization transformation to a polarization state that is orthogonal to its original polarization state (i.e., the p-state of light 107, 114), is transmitted through the PBS 112 and ultimately effects the ‘bright’ pixels at the imaging surface. The light which does not undergo a polarization transformation upon emerging from the reflective light valve is again reflected at the interface 113 as reflected light 118. Because this light is not ultimately incident on the image surface, it effects the ‘dark’ pixels of the image.

As can be appreciated, the light 116 is white light. In order to form the color image on the screen, the color filter or shutter 122 sequentially flashes the colors to illuminate the projection optics 123 and thus form the image. The details of this image formation process using the color shutter 122 are known to the artisan of ordinary skill, and as such, these details are omitted so as to not obscure the disclosure of the example embodiments.

As can be readily appreciated, the light 118, which constitutes the dark light or dark pixels is reflected back to the system 100, and would otherwise be lost in the system. However, in accordance with example embodiments, this reflected light is substantially recovered and introduced substantially uniformly across the image surface (i.e., recycled). In this manner, the overall brightness of the image is improved compared to known systems. Certain aspects of the recycling of the dark-state light as well as other light are described presently in the context of example embodiments.

The light 118 reflected at the PBS is returned to the reflective polarizer 106, where, because its polarization state is parallel to the transmission axis of the polarizer 106, it is transmitted through the rod integrator 104. This light 121 traverses the rod integrator 104 and the quarter wave retarder 108 where its polarization state is rotated by 45°. Next, some of the light is reflected off the inner reflective surface (immediately adjacent to the quarter wave plate 108), traverses the quarter wave retarder 108 again and emerges as light 124. Light 124 is in a state of polarization that is orthogonal to the state of polarization of light 118 (e.g., s-polarized light in keeping with the above example). Moreover, light 124 is in a state of polarization that is substantially reflected by the reflective polarizer 108. As such, this light again traverses the rod integrator 104, the quarter wave retarder 108, is reflected from the reflective surface 119 and traverses the quarter wave retarder 108 again. Thus, upon incidence at the reflective polarizer 106, this light 125 has a polarization vector that is substantially parallel to the transmission axis of the reflective polarizer 106 and is thus transmitted therethrough.

According to the present example embodiment, the dark state light that is normally lost is now reintroduced to the system 100. To this end, this light has a polarization state that is parallel to the transmission axis of the reflective polarizer 106 (p-polarized light in keeping with the above example) and traverses the lens elements 109, the mirror 110 and the lens element 111. As described previously, this polarized light is reflected toward the light valve 115 by the PBS 112. Uniformly, the light valve 115 transforms the polarization state of light 125 to light 126, which is in an orthogonal polarization state to the p-state of light 125 so that it is transmitted by the PBS 112 and to the projection optics. Stated differently, all of the pixels of the light valve are in a state that will effect a transformation of the polarization state of light 125 into a polarization state that is orthogonal to the polarization state of light 125 (e.g., the p-polarized light 125 is transformed uniformly into s-polarized light 126). This light 126 is then incident on the color shutter 122 and ultimately onto the image surface via the projection optics 123.

Through the example embodiments described, the dark state light is reintroduced or recycled as light 126. This light beneficially allows the overall brightness of the image to be improved by providing otherwise lost light to the image surface.

It is noted that the light that is reflected back toward the reflective element 101 from the rod integrator 104 may also be re-introduced into the system. To wit, the light that is reflected by the reflective polarizer 106 or traverses the reflective polarizer 106 in the manner of light 121, or both, and traverses the opening 120 is reflected by the reflective element 101. At least portions of this light then may be reintroduced via the opening 120. This light must undergo any necessary polarization transformation so that its polarization state is substantially parallel to the transmission axis of the reflective polarizer 106. As can be appreciated this further increases the recycling of light to further improve the brightness of the image.

FIG. 2 shows a light valve projection system 200 for color sequential illumination in accordance with an example embodiment. The system 200 is substantially the same as the system 100, however effects the sequential illumination in a different manner. To wit, rather than the shutter 122, the system 200 incorporates a color wheel 201 that includes red, blue and green filters. The color wheel thus scrolls the colors in sequence and in a manner that is well known in the art. As such, many of the details of the system 100 apply to the description of the system 200 and are thus omitted in the interest of brevity.

FIG. 3 shows an alternative embodiment of the light generation and light recycling waveguide. In this example; the light is generated using 3 LED light sources; Green LED 201G, Red LED 201R and Blue LED 201B. Mirror 203 contains in this example 3 holes. The light of each LED enters the waveguide via a corresponding hole in the mirror 203. Each hole is covered with a dichroic mirror (Red dichroic mirror 204R, Green dichroic mirror 204G, Blue dichroic mirror 204B), such that the light of the corresponding LED can pass the dichroic mirror and enter the waveguide 205, while light of the other colors that are bounced back from the further optical system into the waveguide cannot pass this particular dichroic mirror and as such is recycled. In case of LED's color flashes can be generated by time-sequentially flashing the LED's and as such these types of systems require no color wheel or color shutter to generate the colors. In this particular example, light having the wrong polarization is reflected back into the waveguide 205 by a reflective polarizer 206, which light is transferred into the wanted polarization mode using the Lambda/4 film 207 in corporation with the mirror 203.

FIG. 4 shows an embodiment where this illumination method is combined with laser light sources Green Laser 301G, Red Laser 301R and Blue Laser 301B. The recycling efficiency (Eff) of the light bounced back from the projection optics to the mirror 303 is strongly dependent of the ratio's between the surface area (Aₕₒₗₑ) of the holes 320 and the surface area (Aₘᵢᵣᵣₒᵣ) of the mirror 303:
Eff=(1−Aₕₒₗₑ/Aₘᵢᵣᵣₒᵣ).

This efficiency becomes highest at the moment the hole is relatively small. Since the laser light sources offer very compact light beams but have rather limited brightness's, the combination as shown in FIG. 4 becomes a strong combination. In case of a small white area in the picture; most light that originates from the laser light source is focused in this particular white part in an efficient way.

FIG. 5 shows an embodiment where a diffuser 406 is positioned nearby the entrance hole 420 in the mirror 403 where the light from the laser 401 is fed into the Waveguide 405. Due to this diffuser, the light from the laser will become divergent at the moment the light has entered the waveguide, such that a homogeneous light beam has been obtained at the end of this waveguide.

FIG. 6 shows an embodiment of a transmissive LCD panel 500 that can be applied in combination with any of the illumination systems as described in the previous figures. The LCD panel 500 exist of a liquid crystal layer 501 sandwiched between 2 glass substrates 502 and 503. The LCD panel 500 contains a “black mask” 504. The “black mask” 504 is only called black mask because the light that is incident on the LCD panel is blacked by this mask to hit the projection screen, and as such this mask becomes visible on the screen as a black grid patter. In this embodiment of a transmissive LCD, the black mask 504 is made from a highly light reflective material, such that the light that hits this mask is bounced back into the illumination system where it is recycled at the mirrors at the entrance of the waveguide.

Next, the transmissive LCD 500 contains a wire grid analyzer 505. The wire grid analyzer 505 exists of a fine line pattern of electrical conductive lines (e.g. as manufactured by Moxtek), which line pattern is capable to transmit one polarization mode, while reflecting the other one.

FIG. 7 shows the transmissive LCD 500 working in corporation with the illumination system 400. This embodiment has the advantage that light that hits those pixels that needs to remain dark on the projection screen is bounced back by the wire grid analyzer back into the illumination system 400, where it is recycled at the mirror 403 located on the entrance surface of the waveguide, such that this light is capable to pass bright pixels in the displays.

FIG. 8 shows the illumination system 400 working in corporation with a reflective light valve 603. The light that is leaving the waveguide 405 enters a polarizing Beam Splitter 410, where it is reflected towards the reflective LCD panel 603. The Light valve 603 reflects the light back into the Polarizing Beam Splitter 410, where light that is changed from polarization direction by light valve 603 will be transmitted as light 602 where it will enter imaging optics (not shown) to generate a magnified image on a projection surface. All light that enters the Polarizing Beam Splitter 410 and is not changed from polarization will be reflected back into the illumination module 400 and be recycled at mirror 403.

Other alternative embodiments might be projection systems that contain Micro Electronic Mechanical (MEM) based display panels instead of LCD based. In such an embodiment the PBS 112 can be replaced with a Total Internal Reflection (TIR) prism to separate wished light to the screen from the unwished light returned to the illumination system. An example of such TIR can be found in U.S. Pat. No. 4,969,730. Since MEM based display systems do not require polarized light, the polarizing components 108 and 106 are not required in these type of embodiments.

It is possible to operate the principles of the invention in a display system not containing an projection lens 123 to image the display on a screen, but where the display panel 115 is a larger size display panel that is observed directly with the human eye.

The example embodiments having been described in detail in connection through a discussion of exemplary embodiments, it is clear that modifications of the invention will be apparent to one having ordinary skill in the art having had the benefit of the present disclosure. Such modifications and variations are included in the scope of the appended claims. For example, the optical recorder could be a quarter-wave retarder. The invention could be operated in a color sequential system, for example where red, green, and blue light is sequentially provided from a light source, using a color switch filter or color wheel for example. Or, the light sources could be time multiplexed to time sequentially generate light flashes of different colors. The light valve could be a liquid crystal light valve, a ferroelectric liquid crystal light valve, or a non-ferroelectric liquid crystal light valve for example. The liquid crystal light valve could be a twisted nematic liquid crystal light valve or a liquid crystal on silicon (LCoS) light valve for example. The light source could be a gas discharge lamp, or one or more LEDs, or one or more laser light sources for example. The diffuser could be a roughened transparent surface, a diffractive structured element, a holographic element, or a transparent host plate containing transparent guest particles having a different refractive index as the host material for example.

1. A light valve system for recycling light to increase the brightness of an image, comprising:
a light source;
a light valve optically coupled to a polarization or total internal reflection (TIR) based discriminator; and
a light recycling device disposed to transmit light reflected from the polarization or TIR based discriminator to an imaging surface.

2. The light valve system of claim 1, wherein the light valve is optically coupled to the polarization discriminator and the light recycling device selectively alters the polarization state of the light, reflected by the polarization discriminator, that it transmits to the imaging surface.

3. The light valve system of claim 1, wherein the light valve is optically coupled to the TIR based discriminator and the light recycling device is disposed to transmit the light reflected by the TIR based discriminator to the imaging surface.

4. The light valve system of claim 1, wherein the light recycling device is disposed to transmit light reflected from the polarization or TIR based discriminator to the imaging surface such that the reflected light substantially uniformly illuminates the imaging surface.

5. The light valve system of claim 2, wherein the light recycling device includes a rod integrator having a reflective element and an optical retarder at a first end, and a reflective polarizer at a second end.

6. The light valve system of claim 5, wherein the reflective optical retarder transmits light of a first polarization state and reflects light that is of a second polarization state that is orthogonal to the first polarization state, and wherein the first polarization state is substantially parallel to a transmission axis of the optical retarder at the first end.

7. The light valve system of claim 1, where the light source is a gas discharge lamp.

8. The light valve system of claim 1, where the light source is one or more LEDs or laser light sources.

9. The light valve system of claim 8, where each light source is coupled to the waveguide via a separate respective corresponding hole in a mirror.

10. The light valve system of claim 9, where each hole in the mirror is covered with a dichroic mirror allowing the color of its respective corresponding light source to enter the waveguide and to reflect other colors.

11. The light valve system of claim 10, where a diffuser is positioned nearby the entrance hole or holes in the mirror.

12. The light valve system of claim 9, where a diffuser is positioned nearby the entrance hole or holes in the mirror.

13. A method of recycling light in a light valve system comprising:
optically coupling a light valve to a TIR based discriminator; and
increasing the brightness of an image by recycling light reflected by the TIR discriminator back to the system and transmitting the reflected light to an imaging surface.

14. A method of recycling light in a light valve system, the method comprising:
selectively reflecting a portion of light received from a light valve back to the system;
selectively altering the polarization state of light reflected back into the system; and
increasing the brightness of an image by transmitting the reflected light to an imaging surface.

15. The method of claim 14, wherein the portion of light substantially uniformly illuminates the imaging surface.

16. The method of claim 14, including providing a rod integrator having a reflective element and an optical retarder at a first end, and a reflective polarizer at a second end.

17. The method of claim 14, including coupling each of one or more LED or laser light sources to the waveguide via its own separate respective corresponding hole in a mirror.

18. The method of claim 17 including allowing the color of each light source to enter the waveguide and reflect other colors, by covering each respective corresponding hole in the mirror with a dichroic mirror.

19. The light valve system of claim 17, where a diffuser is positioned nearby the entrance hole or holes in the mirror.

20. The light valve system of claim 18, where a diffuser is positioned nearby the entrance hole or holes in the mirror.
